(19) United States
(12) Patent Application Publication
(10) Pub. No.: US 2003/0050382 A1
(43) Pub. Date: Mar. 13, 2003

(54) Method for synthesis of exfoliated polymer/silicate nanocomposite

(75) Inventors: Yeong Suk Choi, Taejeon (KR); Yoon Kyung Kim, Taejeon (KR); In Jae Chung, Seoul (KR)

Correspondence Address: Alan G. Towner, Pietragallo, Bosick & Gordon, One Oxford Centre, 38th Floor, Pittsburgh, PA, 15219, US

(73) Assignee: Korea Advanced Institute of Science and Technology

(21) Appl. No.: 09/990,103

(22) Filed: Nov. 21, 2001

(30) Foreign Application Priority Data
Sep. 11, 2001 (KR) 2001-55942

(51) Int. Cl. C08K 3/34

(52) U.S. Cl. 524/492; 526/218.1; 526/227; 524/558; 524/525

(57) ABSTRACT

Disclosed is a method for producing polymer/silicate nanocomposites via emulsion polymerization, which comprises the steps of:

(a) forming initial particles from a layered silicate and a monomer provided for high molecular weight polymerization using a reactive emulsifying agent containing a functional group having affinity for the layered silicate; and

(b) emulsion polymerizing the initial particles from the step (a) and a monomer additionally provided using a stabilizer to form exfoliated polymer/silicate nanocomposites.

### BACKGROUND OF THE INVENTION

1. Field of the Invention

The present invention relates to a method for synthesis of exfoliated polymer/silicate nanocomposites. More particularly, the present invention relates to a method for synthesis of polymer/silicate nanocomposites having an exfoliated structure by using pure silicates which are not organic substituted.

2. Description of the Related Art

Polymer nanocomposites show excellent mechanical properties and size stability, and reduced permeability to various gases, even when a little silicate is added thereto, unlike the existing microcomposites. Also, the polymer-layered silicate nanocomposites show an excellent thermal stability and have a self fire-extinguishing function. Such properties of the silicate nanocomposites can be attributed to the lamella structure of the silicate, which provides a high aspect ratio and a large area to interact with polymers.

Such being the case, since the polymer-layered silicate nanocomposites have good properties in spite of addition of silicate, they are expected to be applicable to various industrial fields. Indeed, in the United States, Europe, Japan, and like, commercialization of the polymer-layered silicate nanocomposites is in progress, and some of them have been already made commercially available. For example, Toyota (Japan) has commercialized the first nylon-layered silicate nanocomposites for use as timing-belt covers in automobiles.

However, in practice, it is not simple to produce polymer-layered silicate. Since the layered silicates are highly hydrophilic, they are not miscible with common hydrophobic polymers. Accordingly, intercalation of polymers cannot readily be performed. In most cases, the layered silicates are treated with alkylammonium to be hydrophobic and polymers are then intercalated between layers of the silicates to produce nanocomposites.

Many methods for producing such organic substituted polymer-layered silicates are known. There is a method in which monomers in liquid state or monomers dissolved in a solvent are intercalated to organically modified silicate, immediately followed by polymerization to produce nanocomposites (see, for example, A. Usuki, M. Kawasumi, Y. Kojima, A. Okada, T. Kurauchi and O. Kamigaito, J. Mater. Res., 8, 174 (1993)). This method is advantageous in that various monomers can be used to produce polymer silicate. Also, a solution intercalation method is disclosed which involves intercalating polymers dissolved in solvents between the layers of lamella type silicate (see, Ruiz-Hitzky and P. Aranda, Adv. Mater., 2, 545 (1990)).

Giannelis et al. of Cornell University developed a method for producing polymer-layered silicate nanocomposites via a solution intercalation method including directly intercalating molten polymers to the spaces between layered silicates (see, R. A. Vaia, H. Ishii and E. P. Giannelis, Chem. Mater., 5, 1694 (1993)). Recently, a method for producing polymer-layered silicate composite via synthesis of silicate in the presence of polymers was reported (see, K. A. Carrado, P. Thiyagarajan and D. L. Elder, Clays Clay Miner., 44, 506 (1996)).

Also, there have been attempts to produce exfoliated silicate nanocomposites by melt-intercalating or solution-polymerizing polymers to silicates which have been organically modified so as to be more compatible with the hydrophobic polymers. However, when alkylammonium, which comprises a major portion of organic substituents, is used in an excessive amount, it may be extruded to surfaces of nanocomposites, leading to toxicity of nanocomposites. Therefore, manufacturers either need a process to organic substitute silicates, or else they must purchase substituted silicates. In such cases, additional costs for purchasing organic substituted silicates or for treating the toxicity of the silicates are incurred, which increases total production cost of polymer-silicate nanocomposites, reducing competitiveness of the product.

### SUMMARY OF THE INVENTION

In order to address the foregoing problems, the present invention uses pure silicates and a reactive emulsifying agent for preparation of polymer/silicate nanocomposites. Thus, an object of the present invention to provide a method for producing exfoliated polymer/silicate nanocomposites from a pure silicate via emulsion polymerization using water, which is commonly used as a medium for polymerization.

This object is achieved by a method for producing exfoliated polymer/silicate nanocomposites via emulsion polymerization, which comprises the steps of:

(a) forming initial particles from a layered silicate and a monomer provided for high molecular weight polymerization using a reactive emulsifying agent containing a functional group having affinity for the layered silicate; and

(b) emulsion polymerizing the initial particles from the step (a) and a monomer additionally provided using a stabilizer.

### BRIEF DESCRIPTION OF THE DRAWINGS

The above objects, and other features and advantages of the present invention will become more apparent after a reading of the following detailed description when taken in conjunction with the drawings, in which:

FIG. 1 shows X-ray diffraction analyses of exfoliated polystyrene/silicate nanocomposites prepared according to the method described in Example 1 and Example 2, in which curve (a) represents nanocomposites of Example 1 and curve (b) represents nanocomposites of Example 2;

FIG. 2 shows a graph illustrating results of a thermal gravimetric analysis (TGA) of the polystyrene/silicate nanocomposites prepared according to the method described in Example 1; and

FIG. 3 shows a graph of elastic modulus according to varying temperatures of polystyrene without silicate, polystyrene/silicate nanocomposites and polystyrene-methylmethacrylate copolymer/silicate nanocomposites.

### DETAILED DESCRIPTION OF THE INVENTION

The present invention is described in detail below.

The present invention provides a method for producing exfoliated polymer/silicate nanocomposites via emulsion polymerization, which comprises the steps of:

(a) forming initial particles from a layered silicate and a monomer provided for high molecular weight polymerization using a reactive emulsifying agent containing a functional group having affinity for the layered silicate; and

(b) emulsion polymerizing the initial particles from the step (a) and a monomer additionally provided using a stabilizer.

The step (a) to form initial particles is a step to determine the number of emulsion polymer particles in the polymerization system. Usually, this step is performed by adjusting an amount of the initial monomer added in a range of concentration that does not obstruct the stability of the polymerization reaction. The amount of the initial monomer added for formation of the initial particles is generally 1 to 50 parts by weight based on the total amount of added monomers. If the amount of the initial monomer is added in an amount less than 1 part by weight, the number of the produced particles is small and thus the rate of polymerization is lowered. On the other hand, if the added amount of the initial monomer is added more than 50 parts by weight, a temperature of polymerization is raised during the formation of the initial particles, which may cause a convergence reaction. However, the aforementioned range of the added amount of the initial monomer is based on limitations disclosed in the published documents and does not form a critical part of the present invention.

The silicates which can be used in the present invention are not particularly limited as long as they have a structure of lamella. However, for the purpose of facilitating the permeation of polymers between the layers of the silicates, it is preferred to use silicates having an average interlamellar spacing in the range of 7 to 12 Å, and which is also excellent in cation exchange effect.

Specific examples of silicates which satisfy the above requirements may include montmorillonite, hectorite, saponite, fluorohectorite, and the like. These silicates can be applied alone or in any of combinations thereof according to the needs of the users.

The monomers which can be used in the polymerization according to the present invention comprise any monomer which is currently used in the preparation of nanocomposites. For example, these include styrenes or styrene copolymers. Also, any monomer copolymerizable with styrene, for example, methylmethacrylate, butylacrylate, butadiene, isobutylacrylate, isoprene, hydroxyethylmethylacrylate and the like, can be used. These monomers can be used alone or in combinations of any two or more thereof.

The reactive emulsifying agent for mediating the polymerization contains preferably a functional group having affinity for the vinyl group and silicate, although it is not particularly limited. Such an emulsifying agent, for example, may include an amide group, sulfone group, and the like. The reactive emulsifying agents having these functional groups have strong affinity for silicates. Therefore, they can facilitate the intercalation of the monomers between the layers of the silicates. As examples of the reactive emulsifying agent containing the functional groups, 2-acrylamido-2-methyl-1-propane sulfonic acid (hereinafter referred to as AMPS), (3-acrylamidopropyl)trimethylammonium chloride, [2-(acryloyloxy)ethyl]trimethylammonium methyl sulfate, vinylbenzyltrimethylammonium chloride, 3-acrylamido-3-methylbutyltrimethylammonium chloride, N,N-dialkylaminoethylacrylate, N,N-dialkylaminoethylmethacrylate, N,N-dimethylaminoethylacrylate, N,N-dialkylaminoethylmethacrylate, N,N-dimethylaminoethylacrylate, N,N-dimethylaminoethylmethacrylate, N,N-dimethylaminomethylacrylamide, N,N-dimethylaminopropylmethacrylamide, 2-methacrylamidopropyltrimetylammonium chloride and the like. These compounds can be used alone or in combinations of any two or more thereof.

A polymerization initiator which can be used in the emulsion polymerization according to the present invention is not particularly limited but any polymerization initiator commonly used in the emulsion polymerization is adequate. Such an initiator may be at least one selected from, for example, ammonium sulphate, potassium sulphate, azobisisonitrile, Cumene hydroxyperoxide and benzyloxide.

The monomers added in the step (b), after formation of the initial particles, is to compensate lacks of the monomers in growing particles. The addition of the monomers is carried out by suitably adjusting the injection rate so that the injected monomers can be polymerized in the particles. The injection rate is based on limitations disclosed in the published documents (for example, step 3 of Gardon's Theory) and does not form a critical part of the present invention.

For the emulsion polymerization, which is performed after the initial particles have been formed, a stabilizer is needed, which can promote the diffusion of the monomers added later into the inside of the particles. Such a stabilizer may include at least one selected from the group consisting of anionic emulsifying agents such as linear alkylbenzenesulfonate compounds in which the main chain comprises alkyl group or ethylene oxide, nonionic emulsifying agents, rosin soaps, and fat soaps.

As specific examples of the anionic emulsifying agents, sodium dodecylbenzenesulfonic acid, sodium laurylic acid, sodium decylsulfonic acid, sodium dodecylsulfonic acid and rosin, and combinations of any two or more thereof may be included. As specific examples of the nonionic emulsifying agents, N-triethoxylated nonaneamides, decylmethylsulfoxide, and β-dodecylmaltocides, and combinations of any two or more thereof.

Now, the method for producing exfoliated polymer/silicate nanocomposites via emulsion polymerization according to the present invention is described in detail. Amounts of respective ingredients and reaction conditions may be referred to examples commonly carried out in the pertinent field of the present invention, and may be suitably selected therefrom as needed.

Montmorilonite, one of lamellar type silicates which can be used in the present invention, is dispersed in distilled water to form a dispersion. 1 to 20 weight parts of the resulting dispersion, and 0.1 to 5 weight parts of potassium sulfate as a polymerization initiator, 1 to 50 weight parts of styrene as a monomer, 50 to 450 weight parts of distilled water as a dispersion solvent, 0.1 to 30 weight parts of AMPS as a reactive emulsifying agent are put into a polymerization reactor. The reaction mixture is polymerized while being stirred, to form initial particles.

Here, the temperature of the reactor is required to be higher than a decomposition temperature of the used initiator. Thus, when using potassium sulfate having a decomposition temperature of 40° C. or higher as a initiator, the temperature of the reactor should be higher than this temperature. Usually, polymerization conversion rapidly increases as the polymerization rate is raised. Therefore, preferably, the polymerization temperature upon forming the initial particles is 50 to 85° C.

It is not necessary to particularly limit the added amount of the reactive emulsifying agent. However, when using too little of the reactive emulsifying agent, the exfoliation of silicates cannot be smoothly performed. On the other hand, when using it in an excessive amount, viscosity of the polymerization reaction system increases and low molecular weight oligomers are produced in abundance. Therefore, considering these circumstances, we regulated the amount of the reactive emulsifying agent to the aforementioned range. However, it is to be understood that the foregoing range does not impose a critical limit on the present invention.

After the formation of the initial particles, sodium dodecylbenzenesulfonic acid, one of anionic emulsifying agents as a stabilizer, is added to the reactor in an amount of 0.1 to 5 weight parts. Subsequently, the rest of the monomer is continuously or occasionally is added to the reactor, followed by addition of 0.1 to 5 weight parts of potassium sulfate as a polymerization initiator. Thus, the rest of the monomer undergoes the polymerization reaction, thereby forming nanocomposites in a high concentration.

The polymerization temperature upon addition of the rest of the monomer is generally equivalent to or higher than that of the initial polymerization step. The injection rate of the monomer is controlled so that the polymerization conversion of the growing particles is in a range of 85 to 100%. In this way, there are few or no monomers trapped in the inner part of the particles and thus stable particles can be produced. If the monomers are added at once, the stability of the polymers is poor, leading to aggregation of particles.

Advantages of the emulsion polymerization according to the present invention are as follows.

(1) The interlamellar spacing of the silicate is increased in water, a dispersion medium. Accordingly, there is provided an environment in which monomers having low molecular weights can be permeated into the spaces between layered silicates.

(2) Harmful organic solvents are not used in the present method.

(3) The need for organic substitution can be eliminated by employing a reactive emulsifying agent containing a functional group having affinity for silicates.

(4) According to the method of the present invention, mass production of nanocomposites can be realized and thus commercialization is possible.

Now, the present invention will be described in detail with reference to following examples. These examples however, are intended to illustrate the present invention and should not be construed as limiting the scope of the present invention.

### EXAMPLE 1

Preparation of exfoliated polystyrene-silicate nanocomposites using a reactive emulsifying agent: 5 g of montmorillonite (Kunipia-F, Cunimine Co., CEC=119 meq/100) was added to 145 ml of distilled water. The mixture was stirred for 24 hours at room temperature so that the montmorillonite was evenly distributed in the distilled water.

15 weight parts of the resulting dispersion of montmorillonite was put into a reactor along with 10 weight parts of 1% aqueous solution of potassium sulfate as a polymerization initiator, 25 weight parts of styrene as a monomer, 200 weight parts of three times distilled water, and 1.5 weight parts (0.3 g) of AMPS as a reactive emulsifying agent. The reaction mixture was stirred in nitrogen atmosphere at room temperature for 1 hour so that the ingredients were evenly distributed in distilled water.

After completion of the dispersal, the temperature of the reactor is raised to 65° C. Polymerization of initial particles was performed for 1 hour while the temperature of the reactor was kept at the same temperature. Then, 10 weight parts of 10% aqueous solution of sodium dodecylbenzenesulfonic acid as a stabilizer was added to the reactor by means of a syringe. 75 weight parts of styrene was injected at the same temperature for 2 hours in a continuous manner through a syringe equipped with an injection pump. After the injection of monomers was completed, 10 weight parts of an aqueous solution of potassium sulfate was added to the reactor. The temperature of the reactor was raised to 85° C. and kept at that temperature for 4 hours so that the residual monomers were polymerized via emulsion polymerization.

The resulting polystyrene/silicate nanocomposites were dried in a freeze dryer for about one week and then in a vacuum oven at 100° C. for 24 hours or more.

### EXAMPLE 2

Preparation of exfoliated polystyrene methylmethacrylate copolymer-silicate nanocomposites using a reactive emulsifying agent: 5 g of montmorillonite (Kunipia-F, Cunimine Co., CEC=119 meq/100) was added to 145 ml of distilled water. The mixture was stirred for 24 hours at room temperature so that the montmorillonite was evenly distributed in the distilled water.

15 weight parts of the resulting dispersion of montmorillonite is put into a reactor along with 10 weight parts of 1% aqueous solution of potassium sulfate as a polymerization initiator, 25 weight parts of a mixture of methylmethacrylate and styrene in a ratio of 50:50 as monomers, 200 weight parts of distilled water, and 1.5 weight parts (0.3 g) of AMPS as a reactive emulsifying agent. The reaction mixture was stirred in nitrogen atmosphere at room temperature for 1 hour so that the ingredients were evenly distributed in distilled water.

After completion of the dispersal, the temperature of the reactor is raised to 65° C. Polymerization of initial particles was performed for 1 hour while the temperature of the reactor was kept at the same temperature. Then, 10 weight parts of 10% aqueous solution of sodium dodecylbenzenesulfonic acid as a stabilizer was added to the reactor by means of a syringe. 75 weight parts of a mixture of methylmethacrylate and styrene in a ratio of 50:50 was injected at the same temperature for 2 hours in a continuous manner through a syringe equipped with an injection pump. After the injection of monomers was completed, 10 weight parts of an aqueous solution of potassium sulfate was added to the reactor. The temperature of the reactor was raised to 85° C. and kept at that temperature for 4 hours so that the residual monomers were polymerized via emulsion polymerization.

The resulting polystyrene-methylmethacrylate copolymer/silicate nanocomposites were dried in a freezing dryer for about one week and then in a vacuum oven at 100° C. for 24 hours or more.

Using a mixture of methylmethacrylate and styrene as monomers, methylmethacrylate readily distributes toward the inside of the silicate and is copolymerized with styrene, exfoliating the silicates.

### TEST EXAMPLE 1

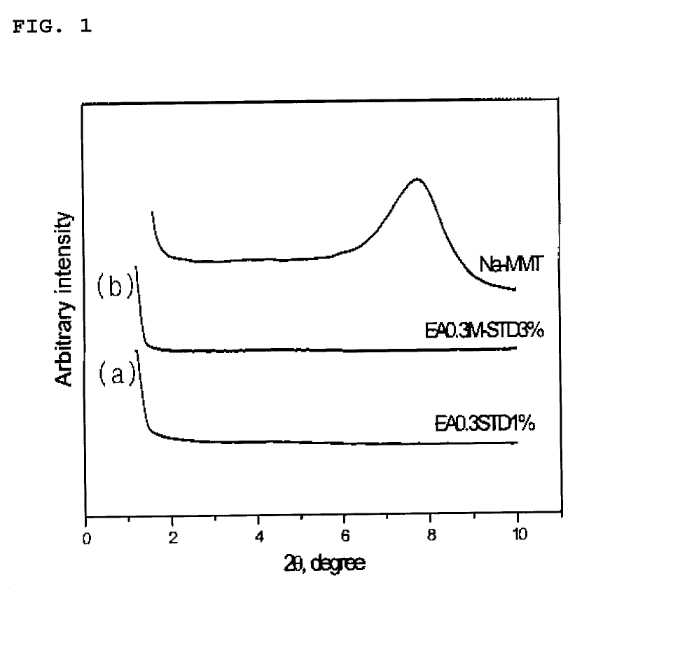

The polystyrene/silicate nanocomposites prepared according to the method described in Example 1 and the polystyrene methylmethacrylate copolymer/silicate nanocomposites prepared according to the method described in Example 2 were examined for their interlamellar spacing according to X-ray diffraction analyses using Rigaku X-ray generator, an X-ray diffraction analyzer (CuKα radiation, λ=0.15406 nm). Results are shown in FIG. 1, in which E represents Extracted, A represents AMPS, and the number after A represents the added amount of the reactive emulsifying agent (g), M represents methylmethacrylate (MMA), S represents styrene, T represents sodium montmorillonite (Na-MMT), D represents anionic emulsifying agent (sodium dodecylbenzenesulfonic acid, DBS-Na), and the % after D represents the weight proportion of sodium montmorillonite in the nanocomposites.

In FIG. 1, the curve (a) shows the results of the X-ray diffraction spectrum for polystyrene/silicate nanocomposites synthesized in Example 1. The results was obtained at a diffraction angle (2θ) of 1.2 to 10° and scanning speed of 2°/min to measure the variation of the interlamellar spacing. In order to remove low molecular weight oligomers and moisture which may show a broad lattice spacing, the nanocomposites were extracted with THF using Soxhlet extraction apparatus for 12 hours prior to the examination of X-ray diffraction spectrum. In the results, no peak indicating regular interlamellar spacings was observed. Therefore, the synthesis of exfoliated polystyrene/silicate nanocomposites is confirmed.

The curve (b) shows the results of the X-ray diffraction spectrum for polystyrene-methylmethacrylate copolymer/silicate nanocomposites synthesized in Example 2. Likewise, no peak indicating regular interlamellar spacings was observed. Therefore, the synthesis of exfoliated polystyrene-methylmethacrylate copolymer/silicate nanocomposites is confirmed.

### TEST EXAMPLE 2

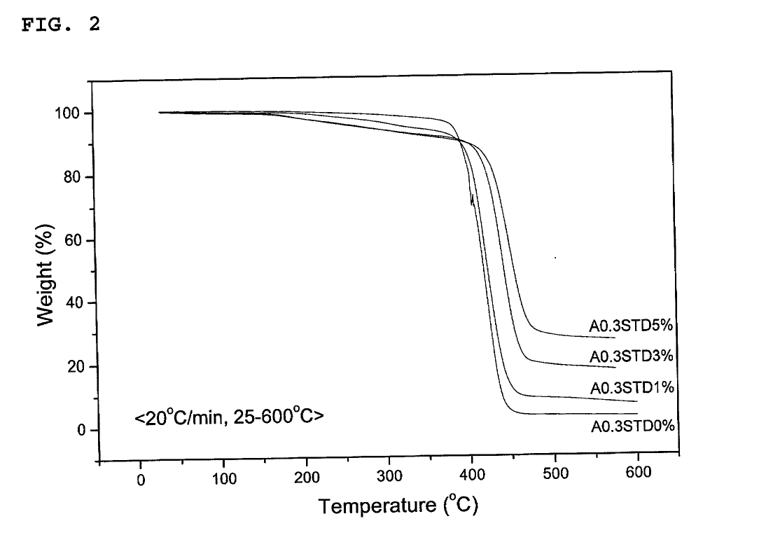

The exfoliated polystyrene/silicate nanocomposites prepared according to the method described in Example 1 were examined for their thermal properties by thermogravimetric analysis (TGA) while varying the amount of silicates, and results are shown in FIG. 2. The reduction of weight near 180° C. is due to decomposition of AMPS. As seen from the curves, as the contents of silicates are increased, the decomposition temperature of polystyrene in the nanocomposites shifts toward a higher temperature. Therefore, it is demonstrated that the polystyrene/silicate nanocomposites produced according to the method of the present invention can be applied in industrial fields demanding for superior thermal properties and size stability.

### TEST EXAMPLE 3

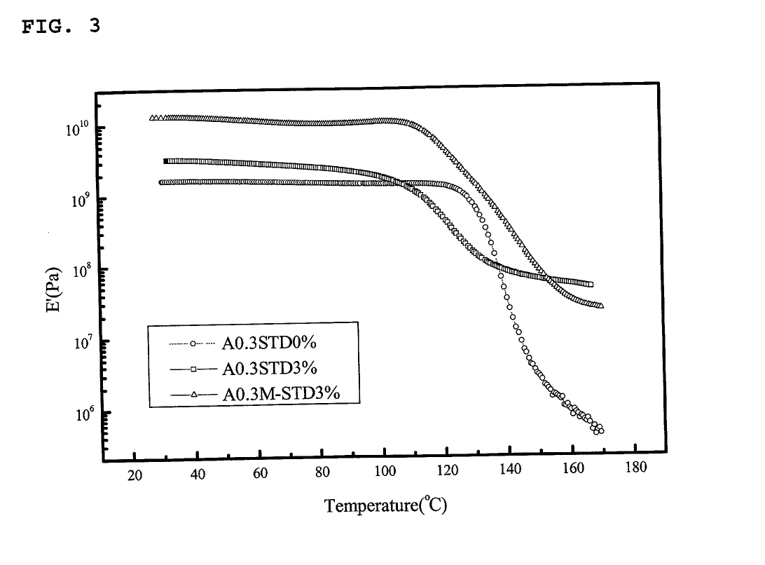

The polystyrene/silicate nanocomposites prepared according to the method described in Example 1 and the exfoliated polystyrene methylmethacrylate copolymer/silicate nanocomposites prepared according to the method described in Example 2, and polystyrene synthesized without clay according to the method described in Example 1, as a reference were examined for their elastic modulus at various temperatures and the results are shown in FIG. 3. Measurements were obtained at temperatures varying from 30 to 170° C. at a rate of 4° C./min.

As compared to the polystyrene (A0.3STD0%), the polystyrene/silicate nanocomposite (A0.3STD3%) shows an increase of 95% of elastic modulus and the exfoliated polystyrene-methylmethacrylate copolmer shows an increase of 660% of elastic modulus. As such, the exfoliated polymer nanocomposites have thermal properties superior to the intercalated nanocomposites, believed to be due to the distribution degree of the silicates within the nanocomposites. Even though silicate is used in the same amount, when the silicate is exfoliated and evenly distributed throughout the polymers, the interactions between the silicate and the polymer are increased, giving excellent mechanical properties. Therefore, these exfoliated nanocomposites according to the present invention can be used as composite materials containing light inorganic substances in applications requiring excellent mechanical properties.

As seen from the results of the Test Examples 2 and 3, the polymer/silicate nanocomposites according to the present invention have excellent thermal properties. Accordingly, they are expected to be applicable to fields demanding heat resistance or size stability. Also, the polymer/silicate nanocomposites are exfoliated type, whereby the silicates are exfoliated and distributed evenly throughout the polymers. Consequently, the interactions between the silicates and polymers are increased, giving improvement in mechanical properties. Thus, the nanocomposite according to the present invention can be used as composite materials with light inorganic substances showing excellent mechanical properties.

While there have been illustrated and described what are considered to be preferred specific embodiments of the present invention, it will be understood by those skilled in the art that the present invention is not limited to the specific embodiments thereof, and various changes and modifications and equivalents may be substituted for elements thereof without departing from the true scope of the present invention.

What is claimed is:

1. A method for producing polymer/silicate nanocomposites via emulsion polymerization, which comprises the steps of:
(a) forming initial particles from a layered silicate and a monomer provided for high molecular weight polymerization using a reactive emulsifying agent containing a functional group having affinity for the layered silicate; and
(b) emulsion polymerizing the initial particles from the step (a) and a monomer additionally provided using a stabilizer to form exfoliated polymer/silicate nanocomposites.

2. The method according to claim 1, wherein the layered silicates have an average interlamellar spacing in the range of 7 to 12 Å.

3. The method according to claim 1, wherein the layered silicates comprises at least one selected from the group consisting of montmorillonite, hectorite, saponite and fluorohectorite.

4. The method according to claim 1, wherein the initiator for emulsion polymerization comprises at least one selected from the group consisting of ammonium sulphate, potassium sulphate, azobisisonitrile, cumene hydroxyperoxide and benzyloxide.

5. The method according to claim 1, wherein the monomers comprises styrenes or styrene copolymers.

6. The method according to claim 1, wherein the reactive emulsifying agent includes a vinyl group for mediating the polymerization.

7. The method according to claim 1 or 6, wherein the reactive emulsifying agent includes at least one selected from the group consisting of an amide group and sulfone group.

8. The method according to claim 7, wherein the reactive emulsifying agent comprises at least one selected from the group consisting of 2-acrylamido-2-methyl-1-propane sulfonic acid (hereinafter referred to as AMPS), (3-acrylamidopropyl)trimethylammonium chloride, [2-(acryloyloxy)ethyl]trimethylammonium methyl sulfate, vinylbenzyltrimethylammonium chloride, 3-acrylamido-3-methylbutyltrimethylammonium chloride, N,N-dialkylaminoethylacrylate, N,N-dialkylaminoethylmethacrylate, N,N-dimethylaminoethylacrylate, N,N-dialkylaminoethylmethacrylate, N,N-dimethylaminoethylacrylate, N,N-dimethylaminoethylmethacrylate, N,N-dimethylaminomethylacrylamide, N,N-dimethylaminopropylmethacrylamide, and 2-methacrylamidopropyltrimetylammonium chloride.

9. The method according to claim 1, wherein the stabilizer comprises at least one selected from the group consisting of anionic emulsifying agents such as linear alkylbenzenesulfonate compounds in which the main chain comprises alkyl group or ethylene oxide, nonionic emulsifying agents, rosin soaps, and fat soaps.

10. The method according to claim 5, wherein the styrene copolymers comprises copolymers of styrene with at least one selected from the group consisting of methylmethacrylate, butylacrylate, butadiene, isobutylacrylate, isoprene and hydroxyethylmethylacrylate.

11. The method according to claim 9, wherein the anionic emulsifying agent comprises at least one selected from the group consisting of sodium dodecylbenzenesulfonic acid, sodium laurylic acid, sodium decylsulfonic acid, sodium dodecylsulfonic acid and rosin.

12. The method according to claim 9, wherein the nonionic emulsifying agent comprises at least one selected from the group consisting of N-triethoxylated nonaneamides, decylmethylsulfoxide and β-dodecylmaltocides.
